(19) United States
(12) Patent Application Publication
(10) Pub. No.: US 2015/0369334 A1
(43) Pub. Date: Dec. 24, 2015

(54) CENTRIFUGAL FORCE PENDULUM DEVICE

(71) Applicant: Schaeffler Technologies AG & Co. KG, Herzogenaurach (DE)

(72) Inventors: Christian DINGER, Lauf (DE); Thorsten KRAUSE, Buehl (DE); Simon SCHÄFER, Buehl (DE); Bernhard JONITZ, Mahlberg (DE)

(21) Appl. No.: 14/765,495

(22) PCT Filed: Feb. 12, 2014
(86) PCT No.: PCT/DE2014/200056

§ 371 Date: Aug. 3, 2015

(30) Foreign Application Priority Data
Feb. 12, 2013 (DE) 10 2013 202 230.1
Nov. 11, 2013 (DE) 10 2013 222 807.4

(51) Int. Cl. F16F 15/14

(52) U.S. Cl. CPC F16F 15/14

(57) ABSTRACT

A centrifugal force pendulum device includes a pendulum flange and at least two pendulum masses attached to both sides of the pendulum flange by a spacer element to make a pendulum mass pair. The pendulum mass pair is guided relative to the pendulum flange by a roller element, and is pivotable to a limited extent. Furthermore, the spacer element is equipped with a damper to damp an impact of the spacer element against an adjacent component, where the damper includes a stopper which limits the maximum deflection of the damper upon impact.

The invention relates to a centrifugal force pendulum device, in particular for use in a drivetrain of a motor vehicle, preferably in a range between a drive motor and a transmission.

### BACKGROUND

A centrifugal force pendulum device is set up to cancel out non-uniformities of a rotary motion. To that end, the centrifugal force pendulum device includes a pendulum flange which is situated so that it can rotate around an axis of rotation. Attached to the pendulum flange is a pendulum mass, which is movable on a predetermined pendulum path in the plane of rotation of the pendulum flange. If the rotary motion of the pendulum flange is accelerated, or decelerated, the pendulum mass moves relative to the pendulum flange and counteracts the acceleration or deceleration.

The pendulum mass is usually guided relative to the pendulum flange by means of a sliding block guide. In a known embodiment, the pendulum flange includes an axial cutout through which a bolt runs. On both axial sides, a pendulum mass is attached to the bolt. The pendulum path is limited by appropriate choice of the cutout.

### SUMMARY OF THE INVENTION

If the bolt runs into a boundary of the cutout in the pendulum flange, then the pendulum masses connected to it can be greatly accelerated. The bolt can thereby be subjected to great material fatigue. In addition, the hard impact can cause a rattling noise, which may be perceived as unpleasant. It is known to surround the bolt with an elastomer, in order to cushion the pendulum masses more gently relative to the pendulum flange. However, such solutions often cannot provide sufficient cushioning or damping. Furthermore, over time the elastomer can be subjected to severe wear.

It is an object of the present invention to provide a centrifugal force pendulum device that is less noisy and more reliable.

According to the invention, a centrifugal force pendulum device is proposed having a pendulum flange and at least two pendulum masses attached to both sides of the pendulum flange by means of a spacer element to make a pendulum mass pair. The pendulum mass pair is guided relative to the pendulum flange by means of a roller element, and is can be pivoted to a limited extent. Furthermore, the spacer element is equipped with a damping means to damp an impact of the spacer element against an adjacent component, where the damping means includes a stopping means which limits the maximum deflection of the damping means upon impact.

In order to make better use of the entire volume of the damping means for damping, in a preferred embodiment the damping means, preferably an elastomer, is vulcanized onto a stopping means, preferably consisting of sheet metal and/or plastic, in particular in disk form. Upon impact of the pendulum masses on the adjacent component, for example the pendulum flange, the energy of impact is transmitted through the stopping means to the extent of the damping means, preferably to the full extent of the damping means. During the deflection, the damping means is subjected to shearing load; that is, it is under shear. As this occurs, opposing forces parallel to the plane of rotation act on different axial sections of the damping means. The load on the damping means preferably acts primarily or completely in shear.

The deflection of the damping means preferably occurs in shear.

In one embodiment, the damping means has a first outside diameter, and at a position spaced axially apart therefrom it has a second outside diameter. The first and second outside diameters may be different. Furthermore, the center points belonging to the first and second outside diameters may be offset from each other radially.

The roller element may be received and rollable in a guideway in the pendulum masses and in a complementarily shaped guideway in the pendulum flange.

The damping means may be situated in an axial region of the spacer element that reaches through a cutout in the pendulum flange.

The damping means may be made of an elastic material. This elastic material may be at least one of the following: an elastomer, a plastic, a rubber or a composite material.

The damping means may be connected to the spacer element by material bonding or by positive-locking The materially bonded connection may be made in particular by means of vulcanizing. A combination of material bonding and positive locking is also possible.

The invention also includes a torque transfer device, such as a hydrodynamic torque converter, and/or a torsional vibration damper, and or a wet-running or dry-running clutch device, and or a dual-mass flywheel having a centrifugal force pendulum device according to one or more of the embodiments specified in the claims.

### BRIEF DESCRIPTION OF THE DRAWINGS

The invention will be described in detail below with reference to the illustrations. The figures show the following details:

FIG. 1: a three-dimensional view of a detail of a centrifugal force pendulum device, and

FIGS. 2-6. details of the centrifugal force pendulum device from FIG. 1 in various embodiments of the invention.

### DETAILED DESCRIPTION

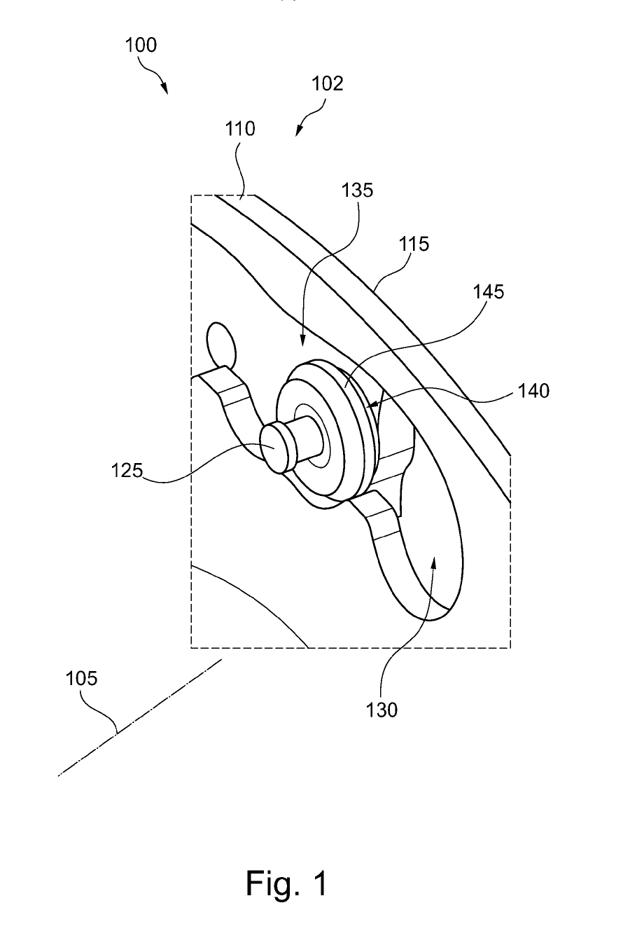

FIG. 1 shows a three-dimensional view of a detail of the centrifugal force pendulum device 100. The centrifugal force pendulum device 100 may be connected to or integrated into a torque transfer device. The torque transfer device may comprise at least one of the following: a hydrodynamic torque converter, a torsional vibration damper, a wet- or dry-running clutch device or a dual-mass flywheel.

A pendulum flange 110 is situated so that it can rotate around an axis of rotation 105. On each of the two axial sides of the pendulum flange 110 is a pendulum mass 115; the pendulum mass 115 toward the viewer is not shown in FIG. 1. Two pendulum masses 115 corresponding to each other form a pendulum mass pair 120, and are connected to each other axially by means of a spacer element 125. The spacer element 125 may comprise in particular a bolt, a roller or a rivet, and is preferably riveted to the two pendulum masses 115.

The spacer element 125 runs through an axial cutout 130 or window in the pendulum flange 110. In the area of the cutout 130 the spacer element 125 carries a roller element 135, whose form is preferably rotationally symmetrical to a longitudinal axis of the spacer element 125. The roller element 135 is set up to guide the pendulum mass pair 120 in relation to the pendulum flange 110, and to limit pendulum travel of the pendulum mass pair. The roller element 135 may alternatively be supported fixedly or rotatably in relation to the pendulum mass pair 120.

Furthermore, the spacer element 125 is equipped with a damping means 140 to damp the impact of the spacer element 125 on an adjacent component, in particular the pendulum flange 110. The damping means 140 includes a stopping means 145, which limits maximum deflection of the damping means 140 upon impact. As explained even more precisely below, to that end the stopping means 145 is preferably disk-shaped, having an inside diameter which is greater than an outside diameter of the spacer element 125 in this area.

At rest, the stopping means 145 is preferably held by the damping means 140 in a position in which there is an annular gap between the stopping means 145 and the spacer element 125. At the end of a pendulum motion of the pendulum mass pair 120, a radially outer surface of the stopping means 145 rests against a boundary of the cutout 130 in the pendulum flange 110. A remaining kinetic energy of the pendulum mass pair 120 is reduced by cushioning while the damping means 140 is deformed, until the inside diameter of the stopping means 145 rests against the outside diameter of the spacer element 125. The stopping means 145 is formed of a sufficiently stiff material to prevent further movement of the spacer element 125 toward the boundary of the cutout 130. The deformation of the damping means 140, which occurs during the described process, preferably occurs in shear so that the load on the damping means 140 is at least partially in shear.

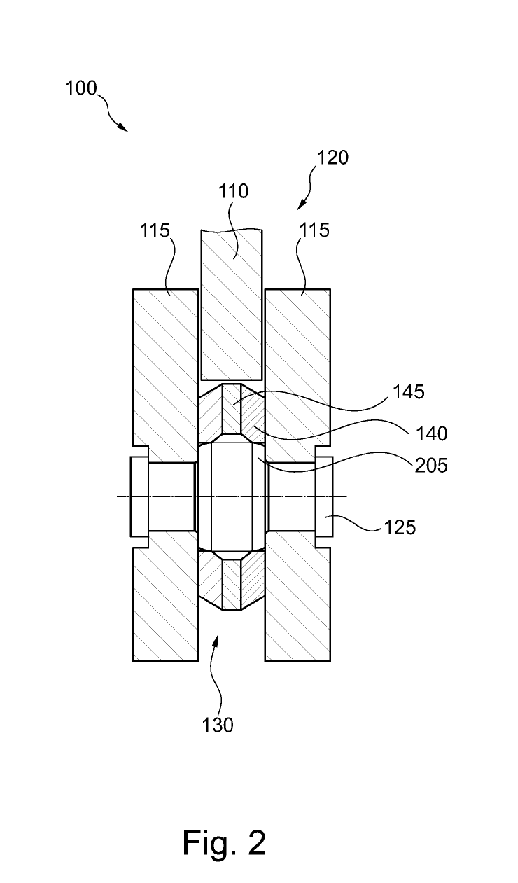

FIG. 2 shows a portion of the centrifugal force pendulum device 100 from FIG. 1 in a first embodiment. The embodiment shown corresponds to that of FIG. 1.

In a first axial region of the pendulum flange 110, the spacer element 125 may have, as shown, a predetermined diameter which is greater than the diameter in cutouts in the pendulum masses 115, through which the axial ends of the spacer element 125 are passed. The axial spacing of the pendulum masses 115 can be limited thereby.

In one embodiment, a roller element 205 between the pendulum masses 115 is applied to the spacer element 125 so as to support a rolling movement of the stopping means 145 or of the damping means 140 around the longitudinal axis of the spacing means 125. In one embodiment, the roller element 205 comprises a sleeve, a journal bearing, a self-lubricating bearing or a roller bearing. In another embodiment, the spacer element 125 can also be rotatably attached to the pendulum masses 115.

The stopping means 145 is held by the damping means 140 in the depicted position, in which the annular gap between the inside diameter of the stopping means 145 and the outside diameter of the spacer element 125 or of the roller element 205 guarantees a predetermined spring deflection 210.

When the pendulum mass pair 120 impacts the pendulum flange 110, in the depiction in FIG. 2 the pendulum flange 110 moves downward, and the pendulum mass pair 120 with the spacer 125, the damping means 140 and the stopping means 145 moves upward. If the stopping means 145 is against the boundary of the cutout 130 in the pendulum flange 110, then the damping means 140 begins to be deformed until the spring travel 210 is exhausted. In this case, it is preferred that the load on the damping means 140 is at least partially, preferably mainly in shear. To that end, the damping means 140 in the depicted embodiment is placed on both sides of the stopping means 145 and frictionally joined with it

In the depicted embodiment, the damping means 140 has a first outside diameter in the area of the stopping means 145, and a second outside diameter on an axial side facing one of the pendulum masses 115. The two diameters are preferably different, with the first outside diameter in the depicted embodiment being greater than the second outside diameter. The center points of the outside diameters can be offset from each other radially or axially.

The two sections of the damping means 140 located on different axial sides of the stopping means 145 are frictionally joined with the stopping means 145, and have mirror-opposite offset rhomboidal cross sections. Axially outer surfaces of the sections of the damping means 140 can be attached additionally to the respective adjacent surfaces of the pendulum masses 115. The attachment of the damping means 140 to the stopping means 145 is preferably accomplished by material bonding, for example by vulcanizing or gluing. The attachment to the pendulum masses 115 can be conducted in a corresponding manner.

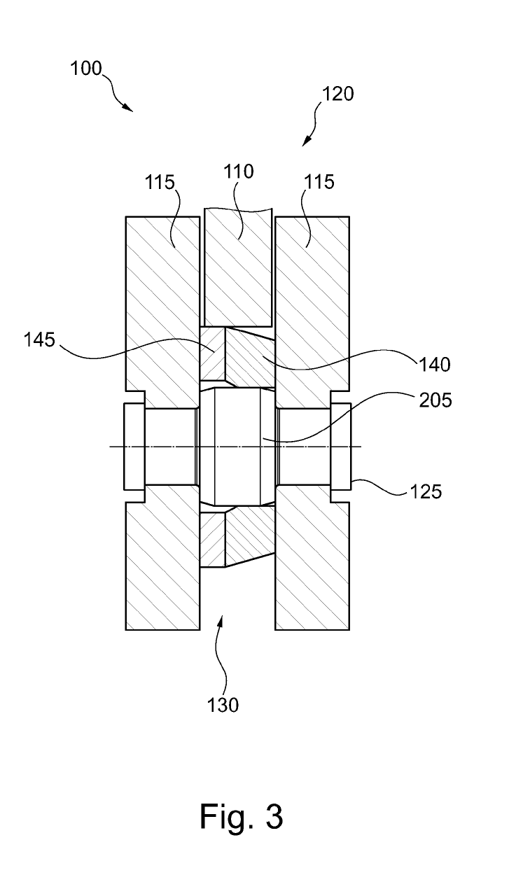

FIG. 3 shows a depiction of a centrifugal force pendulum device 100 corresponding to that of FIG. 2, in another embodiment. In contrast to the embodiment depicted in FIG. 2, here the stopping means 145 is oriented axially sideways, so that it fits axially against one of the pendulum masses 115. The damping means 140 is oriented toward the other axial side. In this case, the cross section of the damping means 140 may again be rhomboidal, as in FIG. 2, or pentagonal, as depicted.

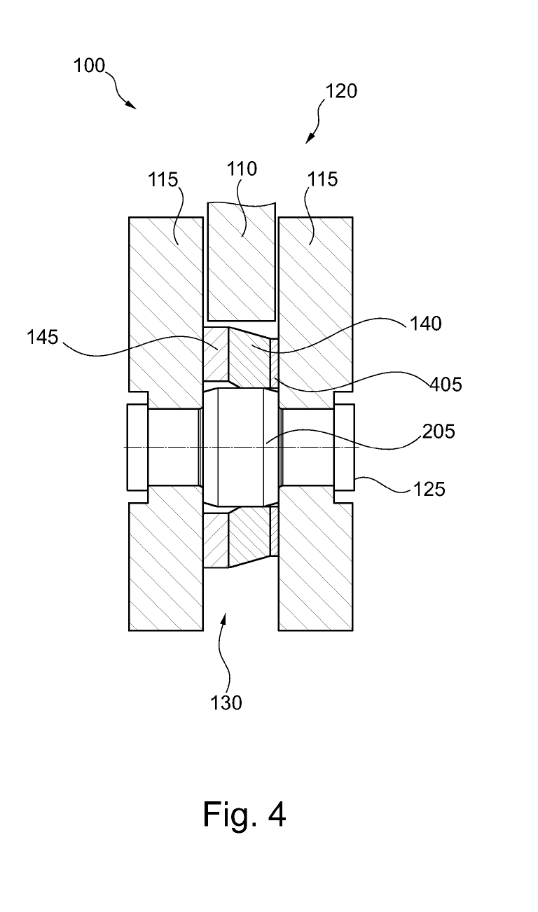

FIG. 4 shows a depiction of another centrifugal force pendulum device 100 corresponding to that of FIG. 2, in another embodiment. In contrast to the embodiment in FIG. 3, the damping means 140 is situated axially between the stopping means 145 and a supporting element 405. The supporting element 405 is preferably disk-shaped, with axial surfaces of the supporting element 405 fitting against the damping means 140 and a pendulum mass 115. An inside diameter of the supporting element 405 preferably corresponds to the outside diameter of the stopping element 125 or the outside diameter of the rolling element 205 at this axial position. An outside diameter of the supporting element 405 is preferably smaller than an outside diameter of the stopping means 145.

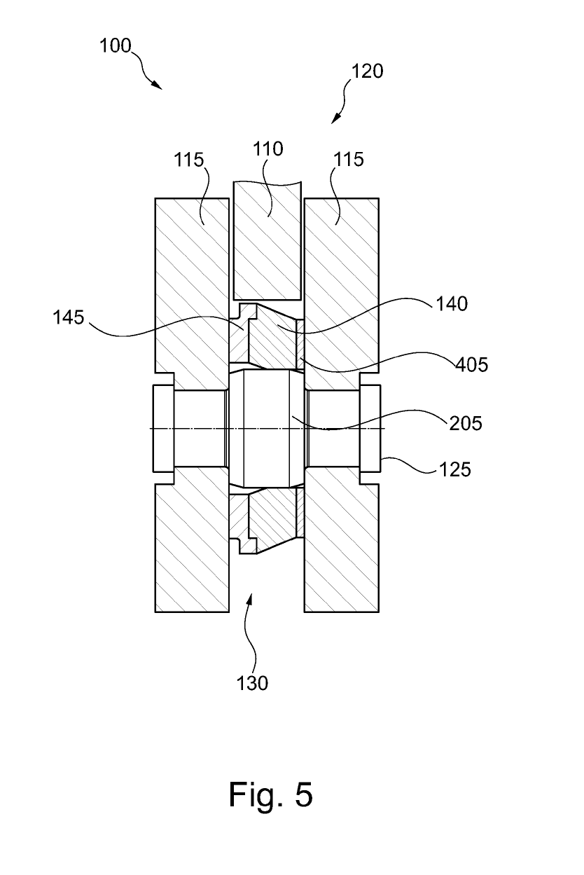

FIG. 5 shows a depiction of a centrifugal force pendulum device 100 corresponding to FIG. 2, in another embodiment. In contrast to the embodiment depicted in FIG. 4, the stopping means 145 has an encircling outer rim which is axially shifted relative to the rest of the stopping means 145. This forms a step having a radially inner contact edge, on which the damping means 140 is held in a positive-locked manner. The supporting element 405 is optional in this embodiment.

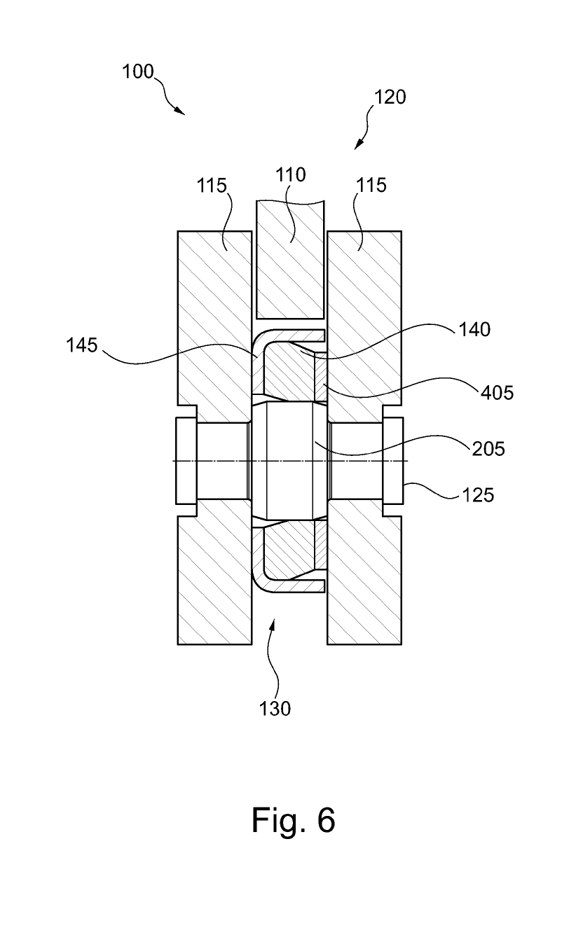

FIG. 6 shows a depiction of a centrifugal force pendulum device 100 corresponding to FIG. 2, in still another embodiment. In contrast to the embodiment shown in FIG. 4, the stopping means 145 has an encircling outer rim which extends axially away from the adjacent pendulum mass 115 to the other pendulum mass 115. This gives the stopping means 145 the form of a pot or bowl. Here too, the supporting element 405 is optional.

### REFERENCE LABELS

100 centrifugal force pendulum device
105 axis of rotation
110 pendulum flange
115 pendulum mass
120 pair of pendulum masses
125 spacer element
130 Cutout
135 rolling element
140 damping means
145 stopping means
205 rolling element
210 spring travel
405 support element

1-10. (canceled)

11. A centrifugal force pendulum device comprising:
a pendulum flange;
at least two pendulum masses fastened on both sides of the pendulum flange by a spacer element to define a pendulum mass pair, the pendulum mass pair being guided relative to the pendulum flange by a rolling element and pivotable to a limited extent;
the spacer element being equipped with a damper to damp impacting of the spacer element on an adjacent component,
wherein the damper includes a stop limiting a maximum deflection of the damper upon impact.

12. The centrifugal force pendulum device as recited in claim 11 wherein a deflection of the damper occurs in shear.

13. The centrifugal force pendulum device as recited in claim 11 wherein the damper has a first outside diameter, and, at a position spaced axially apart therefrom, has a second outside diameter.

14. The centrifugal force pendulum device as recited in claim 13 wherein the first and second outside diameters are different.

15. The centrifugal force pendulum device as recited in claim 13 wherein center points belonging to the first and second outside diameters are offset from each other radially.

16. The centrifugal force pendulum device as recited in claim 11 wherein the rolling element is received and rollable in a guideway in the pendulum masses and in a complementarily shaped guideway in the pendulum flange.

17. The centrifugal force pendulum device as recited in claim 11 wherein the damper is situated in an axial region of the spacer element reaching through a cutout in the pendulum flange.

18. The centrifugal force pendulum device as recited in claim 11 wherein the damper is made of an elastic material.

19. The centrifugal force pendulum device as recited in claim 18 wherein the elastic material is an elastomer or a plastic or a rubber or a composite material.

20. The centrifugal force pendulum device as recited in claim 11 wherein the damper is connected to the spacer element by material bonding or by positive locking.
